(19) United States
(12) Patent Application Publication
(10) Pub. No.: US 2010/0065447 A1
(43) Pub. Date: Mar. 18, 2010

(54) SOLUTION INTENDED MORE PARTICULARLY FOR PRETREATING A HYDROPHILIC SUBSTRATE FOR THE PURPOSE OF IMPROVING AN ADHESIVE BOND UNDER HUMID AND WET CONDITIONS

(75) Inventors: Thorsten Krawinkel, Hamburg (DE); Andreas Junghans, Hamburg (DE); Eugenia Seibel, Hamburg (DE)

Correspondence Address: GERSTENZANG, WILLIAM C.;NORRIS MCLAUGHLIN & MARCUS, PA, 875 THIRD AVE, 8TH FLOOR, NEW YORK, NY, 10022, US

(73) Assignee: TESA SE, Hamburg (DE)

(21) Appl. No.: 12/447,565

(22) PCT Filed: Oct. 18, 2007
(86) PCT No.: PCT/EP2007/061130

§ 371 Date: May 15, 2009

(30) Foreign Application Priority Data
Nov. 3, 2006 (DE) 10 2006 052 262.1
Jun. 27, 2007 (DE) 10 2007 030 196.2

(51) Int. Cl. B65D 25/08; C09D 7/00; B32B 27/06; B65D 85/00

(52) U.S. Cl. 206/219; 106/287.13; 428/355 BL; 206/525

(57) ABSTRACT

Solution for pretreating a hydrophilic surface to impart water repellency, comprising a silane of the formula

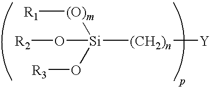

and a component which causes the pH range of the hydrophilic surface to deviate by at least two units from neutral.

The invention relates to a solution, to its use for pretreating a hydrophilic substrate such as glass for the purpose of improving the adhesion of a bonding agent to said substrate under humid and wet conditions, to packs comprising the solution, and to a kit comprising the solution and an adhesive sheet.

The adhesive bonding of lightweight articles in the household is frequently carried out using adhesive tapes, hotmelt adhesives or reactive adhesives. Since the holding power is increased on solid substrates relative to cleavable substrates, bonding takes place, if possible, to metal, ceramic tiles or glass. Besides their use in the household, bonding agents are also used for bonding glass, metal, etc. in industrial production.

A feature common to ceramic and glass surfaces is that they can be classed as being hydrophilic. A property of hydrophilic substrates is the capacity often to have a surface-bound, very thin layer of adsorbed water, which can be removed only at very high temperatures. This layer has the capacity, particularly in cases of high atmospheric humidity or on exposure to water, to accommodate further water and so to affect the bonding performance, up to the point of complete failure of the bond.

The reaction of adhesives can be inhibited by moisture if these adhesives are required to form a covalent bond to the surface in order to fulfill their function.

Pressure-sensitive adhesives (PSAs) are frequently constructed on the basis of acrylates, natural rubber or styrene block copolymers. PSAs for double-sided adhesive tapes in particular are usually composed of acrylates or styrene block copolymers, the holding power frequently being somewhat lower for the acrylates. Under humid conditions, they exhibit precisely the opposite behavior: acrylate PSAs are significantly less susceptible to wetness and humidity than block copolymer compositions.

The construction of the adhesive tapes also contributes to their sensitivity to humidity: hard adhesives and adhesive tapes with rigid carriers are frequently more susceptible than those having very flexible carriers. Double-sided adhesive tapes with intermediate foam carriers, in particular, react sensitively to humidity when they are bonded to hydrophilic substrates.

Hotmelt adhesives are composed of styrene block copolymers or of ethylene-vinyl acetate. Both kinds of hotmelt adhesive are susceptible to humidity.

Industrial solutions to this problem are known. For instance, prior to bonding, glasses are coated with adhesion promoters which hydrophobicize the surface and hence eliminate the aforementioned layer of water. The hydrophobicization is carried out using organosilanes. The most frequently employed in this context are those of the general formula

(RO)₃Si—(CH₂)ₙ—X

where R═CH₃ or C₂H₅,
n=1 to 12, and
X is a functional group.

Following the application of a silane to the hydrophilic surface, a covalent bond is formed between surface and silane. If the surface has been completely silanized, the film of water described above is removed and can also not be formed again, and so the water is no longer able to run behind the bond.

There are silanes which react with adhesive and surface, and silanes which hydrophobicize only the surface, in order to facilitate subsequent bonding and strengthen the adhesive bond. The use of such a silane is described, for example, in WO 2005/040296 A1, in which a silane is applied to a pressure-sensitive adhesive prior to bonding. After bonding it is necessary to wait for at least 24 hours until the ultimate bond strength is reached.

Moreover, these silanes can be subdivided into reactive silanes and moderately reactive silanes. Reactive silanes lead within a few minutes to effective hydrophobicization of a surface, an effect which with moderately reactive silanes is achieved only after hours. The advantage of moderately reactive silanes, however, is their long shelf life of more than six months, even in solutions with a low water content. The group of the reactive silanes includes, for example, γ-aminopropyltriethoxysilane. In contrast, 3-glycidyloxypropyltrimethoxysilane is classed as moderately reactive.

WO 2005/040296 A1, then, shows the use of a solution of 3-glycidyloxypropyltrimethoxysilane for the purpose of improving the bonding of acrylate adhesives to glass surfaces. In that application the contact between adhesive and surface is produced before the solvent has evaporated, in order to achieve a covalent attachment of the silane both to the glass surface and to the adhesive. After contact has been produced, it is necessary to wait 72 hours before the bond can be subjected to any loading.

The approach set out in WO 2005/040296 A1 is acceptable if it is possible to observe the waiting time of 72 hours. In many cases, however, this waiting time leads to a delay in production. If, furthermore, the pretreatment of the surface is to be undertaken by the end user, in the case of private applications, a shortening of the waiting time is an absolute necessity. The use of a reactive silane such as, for example, γ-aminopropyltriethoxysilane, which is described in DE 198 13 081 A1, does not provide a solution to the problem either, since there the shelf life is too short. Consumer products, for example, are frequently in the stockroom for quite some time, or at the customer's premises, before being employed. Storage times of two years between production and use are not uncommon.

It is an object of the invention to shorten significantly the reaction time of a moderately reactive silane, so that the waiting time in the case of its use as an adhesion promoter can be lowered to below 20 hours. At the same time the stability on storage must be retained.

This object is achieved by means of a solution as set out in the main claim. The dependent claims provide advantageous developments of the subject matter of the invention. The invention further relates to uses of the solution of the invention, and also to a set comprising the solution of the invention and an adhesive sheet.

The invention accordingly provides a solution intended more particularly for pretreating a hydrophilic surface for the purpose of hydrophobicization, comprising a silane of the formula

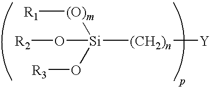

with
R₁, R₂, and R₃ independently of one another selected from the group consisting of methyl, ethyl, 2-methoxyethyl, and isopropyl
m=0 or 1
n=0 to 12
p=1 or 2
and if p=1
   Y=a functional group selected from the group consisting of alkyl, vinyl, phenyl, cyclobutyl, cyclo-pentyl, cyclohexyl, glycidyl, glycidyloxy, isocyanato, ureido, —CF₃, —(CF₂)_{q}CF₃ with q=1 to 12, cyanide, halide, (meth)acryloyl, (meth)acryloyloxy, —NH—CH₂—CH₂—NR⁴R⁵, —NR⁴R⁵ (with R⁴ and R⁵ independently of one another selected from the group consisting of H, alkyl, phenyl, benzyl, cyclopentyl, and cyclohexyl)
or if p=2
   Y═O, S, NH
      and also comprising a component whose effect is that the pH range of the hydrophilic surface deviates by at least two units from the neutral range.

Surprisingly the solution of the invention means that, besides the deviation of the pH of the adhesion promoter solution by at least two pH units from the neutral range, the storage stability of the adhesion promoter is retained even with the changed pH.

In one advantageous development of the invention the solution is an organic solution—that is, a solution comprising one or more organic solvents.

With further preference the boiling point of the solvent or the solvent mixture is between 25 and 120° C., in order to allow very rapid evaporation after the solution has been applied to the surface.

With further preference the solution of the invention has a silane concentration of 0.01% to 5% by weight, preferably 0.1% to 3% by weight.

It is further advantageous if, when the solution of the invention is applied, there is no need for special protective measures such as gloves, which is why very largely unhazardous solvents are preferably employed, such as ethanol or isopropanol, for example. Further solvents, which can be used alone or in a mixture, are, for example, n-propanol, n-butanol, isobutanol, sec-butanol and/or tert-butanol.

A small fraction of water (up to about 5% by weight) may be present in the solution, without adversely affecting the storage stability. Significantly higher water fractions, however, considerably shorten the storage life.

Accordingly the solution advantageously contains not more than 5% by weight of water, preferably not more than 2% by weight of water, and more preferably not more than 1% by weight of water.

The pH at which the reaction rate is particularly fast or slow varies according to the particular silane. From one silane to another, the best pH values for a sufficiently rapid reaction on the hydrophilic surface and for good storage stability are situated either in the moderately acidic range (pH 2 to 5) or in the moderately alkaline range (pH 9 to 13).

The silane solution is therefore admixed with, as a component, accelerators in the form of an alkali or acid, which ought to contain as little water as possible. The acids and alkalis chosen ought not to be too strong, but must as far as possible evaporate following application to the surface, so that there are no residues which have an adverse influence on bonding. Protic acids such as acetic acid (concentrated) and ammonia as a solution in the solvent used have shown themselves to be particularly effective here. Further acids which can be used are, for example, formic acid and propionic acid. Further bases are, for example, methylamine, dimethylamine, trimethylamine, ethylamine, diethylamine, triethylamine, propylamine, isopropylamine, dipropylamine, diisopropylamine, butylamine, sec-butylamine and/or tert-butylamine. The pH can be adjusted via the amount of acid or alkali, respectively.

As well as accelerating the reaction by means of a pH-modifying component, it is also possible to contemplate slowing down this reaction by means of a corresponding pH. In that case a reactive silane would be selected and the shelf life of this silane would be increased by the setting of a corresponding pH. The reaction time after application to the hydrophilic surface ought in this case still to be sufficiently short.

The mode of operation of the solution of the invention can be elucidated by the example of the reaction of silanes with a glass surface. The reaction of the silanes with the glass surface takes place in two steps. First, the silanes must be hydrolyzed—that is, the alcoholic groups RO are eliminated and replaced by hydroxyl groups. The resulting Si—OH (silanol) groups then react first with themselves and second with the OH groups of the glass surface, producing a covalent bond. When the glass surface is completely silanized, the water film described above is removed and can also no longer be formed, and, consequently, the water is no longer able to run behind the bond.

The presentation form is critically important particularly for application in the private sector by the end user. Preference is given here to dispensing in bottles or cans, as a pump spray or an aerosol, for example, or to dispensing in sealed-edge pouches containing a nonwoven material. A sealed-edge pouch of this kind is composed of a solvent-impermeable and water-impermeable foil, such as a PE/Al/PET composite, for example. This foil can be welded under the action of heat. Within the resultant pouch there is a cloth, most preferably a nonwoven material, which is impregnated with the adhesion promoter solution, composed at least of silane, accelerator, and solvent. For application, the end user can tear open the pouch, take out the impregnated cloth, and use it to pretreat his or her ceramic substrate, tile or glass, to which bonding is to take place.

Another preferred presentation form entails dispensing into bottles comprising a reservoir and an applicator. In this case the silane solution is applied by contacting the surface with the applicator.

A particularly preferred presentation form is a pack in which the silane-containing solution and the accelerator employed with preference are separated from one another until the user wishes to employ the adhesion promoter solution consisting of silane, accelerator, and solvent.

This applies in particular to the case where the silane and the accelerator are in solution in the same solvent.

For example, the pack may consist of a plastic pouch having two chambers, a first chamber containing the silane, preferably in a solvent, and a second chamber, spatially separate from the first, containing the component whose effect is that the pH range of the hydrophilic surface deviates by at least two units from the neutral range, the chambers being separated from one another by a dividing membrane which can be opened as required, either, for example, by simple pressing on one or both chambers, or by extraction of the membrane. The two chambers may also be linked to one another via a common weld seam, which at least in sections can be opened by means of pressure, leading likewise to the mixing of the contents of the two chambers.

Furthermore, in addition, it is possible in a further chamber for the nonwoven material to be impregnated with the ultimately complete adhesion promoter solution to be integrated into the pack, in a third chamber, for example, which may be joined detachably with the other two. In another embodiment the nonwoven material and the two-chamber pouch described may be surrounded by (cardboard) packaging.

When the two pouches of the two-chamber pack are opened, the two solutions become mixed with one another only a short time prior to application. As a result of the spatial separation, a considerable increase in storage stability is achieved by comparison with the mixtures which are prepared immediately after the preparation of the individual components.

Besides the aforementioned two-chamber pouches, separation may also take place in a two-chamber plastic bottle of the kind used for two-component adhesives and of the kind widespread in the cosmetics industry, in which case, for example, both liquids are brought into contact with one another in a mixing head, via a pump mechanism, for example, before leaving the pack.

In that case it is then possible, rather than a two-chamber bottle, to use a tube with two chambers.

Very particular preference is given to those pack solutions in which the two liquids are separate and in which the user himself or herself is unable to come into contact with the two liquids or with the resultant adhesion promoter solution during application. This can be realized, for example, by short-circuiting the two liquid-comprising pouches and directly wetting a correspondingly packaged nonwoven material which serves for application of the resultant adhesion promoter solution. Preferably only a small part of the nonwoven material comes into contact with the liquids, thus leaving on the nonwoven material a region which is not impregnated with liquid and which is used as a grip area via which the user is able to hold the nonwoven material.

A further possibility is a pack in which the two solutions are present separately from one another but can be taken up in succession using a nonwoven material or cotton or foam rod, the two solutions only then becoming mixed.

Optimally the reaction on the surface then takes place within a few minutes, so that subsequently the bonding operation and also the loading of the bond can take place. Depending on the nature of the silane and of the accelerator system, exposure to water or humidity may then take place immediately, or else it is necessary to wait for a while. This time may be adapted to the particular application.

Adhesive tapes which can be used preferably in combination with the invention are highly elastic adhesive sheets for redetachable bonds which are redetachable by pulling in the direction of the bond plane. These adhesive sheets are available commercially from tesa AG under the names “tesa Powerstrips”® and “tesa Posterstrips”® and “tesa Powerstrips System-Haken”®, a so-called system hook with base plate and attachable decorative hook.

Elastically or plastically highly extensible pressure-sensitive adhesive strips which can be redetached without residue and destruction by extensive stretching in the bond plane are known, furthermore, for example, from U.S. Pat. No. 4,024,312 A, DE 33 31 016 C2, WO 92/11332 A1, WO 92/11333 A1, DE 42 22 849 A1, WO 95/06691 A1, DE 195 31 696 A1, DE 196 26 870 A1, DE 196 49 727 A1, DE 196 49 728 A1, DE 196 49 729 A1, DE 197 08 364 A1, DE 197 20 145 A1, DE 198 20 854 A1, WO 99/37729 A1, and DE 100 03 318 A.

### Test Methods

In contrast to the customary testing for the water resistance of a bond, particularly in the area of pressure-sensitive adhesives and adhesive tapes, no peel test is carried out before and after water storage, since in this case the bond has not been subjected to load, and so it is much more difficult for the water to penetrate the joint.

Instead, a hook of a certain size is bonded and is loaded with a defined weight. The bond is then stored at 35° C. and 85% relative humidity, and is sprinkled with water at intervals of 24 hours, and the holding time in hours is recorded. As a control, a bond without adhesion promoter solution is carried out as well.

The examples below are intended to illustrate the invention, without any wish that it should be restricted.

### EXAMPLES

### Preparation of Adhesion Promoters

### Comparative Example 1

1 g of γ-aminopropyltriethoxysilane is dissolved in 99 g of ethanol (anhydrous). 1 ml of this solution is placed together with a nonwoven PP material with an area of 6×12 cm into an aluminum-coated sealed-edge pouch, which is welded.

### Comparative Example 2

1 g of 3-glycidyloxypropyltrimethoxysilane is dissolved in 99 g of ethanol (anhydrous). 1 ml of this solution is placed together with a nonwoven PP material with an area of 6×12 cm into an aluminum-coated sealed-edge pouch, which is welded.

### Example 3

1 g of 3-glycidyloxypropyltrimethoxysilane and 1 g of ammonia solution in ethanol (20% by weight) are dissolved in 98 g of ethanol (anhydrous). 1 ml of this solution is placed together with a nonwoven PP material with an area of 6×12 cm into an aluminum-coated sealed-edge pouch, which is welded.

To investigate the solutions, two pouches of each solution are opened, and a ceramic tile with a smooth glaze is brushed with each impregnated nonwoven material. After a waiting time of 15 minutes, on the one hand, a double-sided acrylate tab, tesa 4952 (a double-sided adhesive tape with a foam carrier and an aging-resistant acrylate adhesive, with a thickness of 1.2 mm and a bond strength for steel of 14 N/25 mm), in a size of 50×19 mm, and, on the other hand, three Powerstrips® Large from tesa (double-sidedly adhesive, carrierless, individually enveloped diecuts with an adhesive based on synthetic rubber, with a thickness of 0.65 mm and a bond strength for steel of 74.0 N/25 mm), are adhered to the pretreated tile. These systems are described extensively in DE 33 31 016 C2, DE 42 22 849 A1, DE 42 33 872 A1, DE 44 31 914 A1, DE 195 37 323 A1, DE 197 08 364 A1, DE 197 29 706 and DE 100 33 399 A1. Adhered to the bonding agents, with a pressure of 100 N, is a cleaned steel base plate whose construction is such that it is possible to mount a hook body with a vertically protruding metal rod. The tiles are fixed vertically, and at a distance of 50 mm a weight of 200 g in the case of the acrylate tab and 1 kg in the case of the Powerstrip is suspended from the hook. After a waiting time of 2 hours or 24 hours, water (2 ml) is trickled from above onto the bond. This wetting is repeated every 24 hours. A measurement is made of the time after which the hook falls from the wall. As a comparison, hooks without adhesion promoter are suspended.

This experiment is carried out with fresh samples and stored pouches (2 months at 40° C.). The results can be seen from table 1.

TABLE 1

| | Waiting time in hours after the first addition of water | | | |
|---|---|---|---|---|
| | | | | Without |
| | Comparative | Comparative | Example | adhesion |
| | example 1 | example 2 | 3 | promoter |
| Fresh solution | >500 | 6 | >500 | 1 |
| 2 h waiting time | | | | |
| acrylate tab | | | | |
| Fresh solution | >500 | >500 | >500 | 2 |
| 24 h waiting time | | | | |
| acrylate tab | | | | |
| Fresh solution | >500 | 2 | >500 | <1 |
| 2 h waiting time | | | | |
| Powerstrips | | | | |
| Fresh solution | >500 | >500 | >500 | 1 |
| 24 h waiting time | | | | |
| Powerstrips | | | | |
| Stored solution | 2 | 3 | >500 | |
| 2 h waiting time | | | | |
| acrylate tab | | | | |
| Stored solution | 3 | >500 | >500 | |
| 24 h waiting time | | | | |
| acrylate tab | | | | |
| Stored solution | 1 | 2 | >500 | |
| 2 h waiting time | | | | |
| Powerstrips | | | | |
| Stored solution | 2 | >500 | >500 | |
| 24 h waiting time | | | | |
| Powerstrips | | | | |

It is evident that only with a suitable combination of silane and accelerator is it possible to have a sufficiently rapid reaction and yet good stability on storage.

1. A solution for pretreating a hydrophilic surface to impart water repellency, comprising a silane of the formula 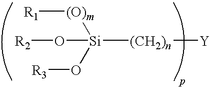
wherein
R₁, R₂, and R₃ are independently of one another selected from the group consisting of methyl, ethyl, 2-methoxyethyl, and isopropyl
m=0 or 1
n=0 to 12
p=1 or 2
and if p=1
Y=a functional group selected from the group consisting of alkyl, vinyl, phenyl, cyclobutyl, cyclopentyl, cyclohexyl, glycidyl, glycidyloxy, isocyanato, ureido, —CF₃, —(CF₂)_{q}CF₃ with q=1 to 12, cyanide, halide, (meth)acryloyl, (meth)acryloyloxy, —NH—CH₂—CH₂—NR⁴R⁵, and —NR⁴R⁵ with R⁴ and R⁵ independently of one another being selected from the group consisting of H, alkyl, phenyl, benzyl, cyclopentyl, and cyclohexyl
or if p=2
Y═O, S, NH
and also comprising a component which causes the pH of the hydrophilic surface to deviate by at least two units from the neutral range.

2. The solution of claim 1, wherein the silane is present in a concentration of 0.1% to 5% by weight in a solvent or a solvent mixture.

3. The solution of claim 1 having a pH between 2 and 5.

4. The solution of claim 1 having a pH between 9 and 13.

5. The solution of claim 3, wherein the pH is adjusted using formic, acetic and/or propionic acid.

6. The solution of claim 4, wherein the pH is adjusted using ammonia, methylamine, dimethylamine, trimethylamine, ethylamine, diethylamine, triethylamine, propylamine, isopropylamine, dipropylamine, diisopropylamine, butylamine, sec-butylamine and/or tert-butylamine.

7. The solution of claim 1, comprising not more than 5% by weight of water.

8. The solution of claim 1, comprising a solvent or solvent mixture having a boiling point of below 120° C.

9. The solution of claim 1, wherein the solvent is ethanol and/or isopropanol.

10. The solution of claim 1, present in the form of a pump spray or an aerosol or in sealed-edge pouches containing a nonwoven material.

11. A method for hydrophobicizing hydrophilic surfaces to improve the service life of the adhesive bond of an adhesive on the surface under the influence of moisture and wetness, which comprises applying the solution of claim 1 to said surface.

12. A method for hydrophobicizing hydrophilic surfaces and subsequently bonding an adhesive sheet thereto which is redetachable without damage by pulling in the direction of the bond plane and is comprised of an adhesive based on polymers and/or copolymers of synthetic rubber and/or natural rubber, which comprises applying the solution of claim 1 to said surfaces prior to bonding said adhesive sheet thereto.

13. A pack comprising a solution of claim 1, a first chamber of the pack containing the silane, optionally in a solvent, and a second chamber, spatially separate from the first, containing a component which causes the pH of the hydrophilic surface to deviate by at least two units from neutral.

14. The pack of claim 13, wherein the silane which is optionally in a solvent, and the component, are not mixed with one another until immediately prior to use, and at that point they are mixed by eliminating the spatial separation of the two chambers.

15. The pack of claim 13 adapted to enable a user to avoid contact with the complete mixture of the silane, which is present optionally in a solvent, and the component until the mixture is applied to the substrate.

16. A set comprising a solution of claim 1 and an adhesive sheet for fixing an article, the adhesive sheet, with an adhesive based on polymers and/or copolymers of synthetic rubber and/or natural rubber, being redetachable without damage by pulling in the direction of the bond plane.

17. The solution of claim 7, wherein said amount of water is not more than 2% by weight.

18. The solution of claim 17, wherein said amount of water is not more than 1% by weight.
